(19) United States
(12) Patent Application Publication
(10) Pub. No.: US 2009/0293287 A1
(43) Pub. Date: Dec. 3, 2009

(54) SCISSORS

(75) Inventor: Kunio Suzuki, Sanjyo-shi (JP)

Correspondence Address: GRIFFIN & SZIPL, PC, SUITE PH-1, 2300 NINTH STREET, SOUTH, ARLINGTON, VA, 22204, US

(73) Assignees: AIHOU CO., LTD., Sanjyo-shi, Nigata (JP); UCHIDA YOKO CO., LTD., Tokyo (JP)

(21) Appl. No.: 11/815,083

(22) PCT Filed: Jan. 9, 2007
(86) PCT No.: PCT/JP2007/050107

§ 371 Date: Jul. 30, 2007

(30) Foreign Application Priority Data
Nov. 14, 2006 (JP) 2006-308173

(51) Int. Cl. B26B 13/00

(52) U.S. Cl. 30/226

(57) ABSTRACT

The present invention provides multi-blades scissors capable of reducing a load generated when a relatively hard object is cut.

There is provided scissors including a plurality of pairs of blades, a first pair of blades among the plurality of pairs of blades deviating from a second pair of blades disposed adjacent to the first pair of blades with respect to a timing at which blades start engaging with each other.

### FIELD OF THE INVENTION

The present invention relates to scissors, and more particularly to scissors including a plurality of pairs of blades.

### BACKGROUND ART

There have been suggested a lot of scissors having a plurality of pairs of blades for cutting an object at a time into a lot of pieces.

For instance, Japanese Patent Application Publication No. 10-118355 has suggested scissors having three pairs of blades.

The suggested scissors makes it possible to provide three cutting lines to an object (for instance, paper).

Patent reference 1: Japanese Patent Application Publication No. 10-118355 (FIG. 2)

### DISCLOSURE OF THE INVENTION

### Problems to be Solved by the Invention

In the above-mentioned scissors having three pairs of blades, the three pairs of blades simultaneously start engaging with each other to thereby cut an object.

There is caused no problem when soft object such as paper is to be cut by the above-mentioned scissors. However, there is caused a problem that a big load exerts on a user when a relatively hard object such as cardboard or resin is to be cut by the above-mentioned scissors. Specifically, since the three pairs of blades simultaneously start engaging with each other, a load three times greater than a load acting on each pair of blades exerts on a hand of a user, resulting in that it is quite difficult for a user to cut a relatively hard object with the scissors having three pairs of blades.

The above-mentioned problem can be found not only in scissors having three pairs of blades, but also in scissors having four or more pairs of blades.

In view of the above-mentioned problem in the conventional scissors having a plurality of pairs of blades, it is an object of the present invention to provide scissors having a plurality of pairs of blades which is capable of reducing a load exerting on a user when a relatively hard object is to be cut therewith.

### Solution to the Problems

Hereinbelow is described the solution to the above-mentioned problem through the use of reference numerals used in a later described “embodiments of the present invention”. The reference numerals are indicated only for the purpose of clearly showing correspondence between claims and the embodiments. It should be noted that the reference numerals are not allowed to interpret claims of the present application.

In order to achieve the above-mentioned object, the present invention provides scissors (100, 200) including a plurality of pairs of blades (110, 120, 130: 210, 220, 230) arranged in parallel with one another, wherein a first pair of blades (120: 210) among the plurality of pairs of blades (110, 120, 130: 210, 220, 230) deviates from a second pair (110, 130: 220, 230) of blades disposed adjacent to the first pair of blades (120: 210) with respect to a timing at which blades start engaging with each other.

For instance, a pair of blades (110) disposed at an outermost may be designed to first start engaging with each other, and, a pair of blades (120, 130) disposed adjacent thereto may subsequently start engaging with each other.

As an alternative, a pair of blades (210) disposed at a center among the plurality of pairs of blades may be designed to first start engaging with each other, and, a pair of blades (220, 230) disposed adjacent thereto may subsequently start engaging with each other.

The present invention further provides scissors including a plurality of pairs of blades (110, 120, 130: 210, 220, 230) arranged in parallel with one another, wherein each pair of blades has a height (A, B, C) different from one another among the plurality of pairs of blades (110, 120, 130: 210, 220, 230).

For instance, it is preferable that a pair of blades (110) disposed at an outermost has a greatest height (A), and a pair of blades (120, 130) disposed remoter from the pair of blades disposed at an outermost has a smaller height (B, C).

As an alternative, a pair of blades (210) disposed at a center may be designed to have a greatest height (A), and a pair of blades (220, 230) disposed remoter from the pair of blades disposed at a center may be designed to have a smaller height (B, C).

### Advantages Provided by the Invention

In the scissors in accordance with the present invention, a plurality of pairs of blades starts engaging with each other at a timing different from one another. Accordingly, the plurality of pairs of blades starts cutting an object at a timing different from one another.

In the conventional scissors having three pairs of blades, since the three pairs of blades simultaneously start engaging with each other, there was caused a problem that a big load exerted on a hand of a user.

In contrast, since a plurality of pairs of blades starts cutting an object at a timing different from one another in the scissors in accordance with the present invention, a load to be exerted on a hand of a user is divided, and hence, a big load does not exert at a time on a hand of a user. Thus, even if a relatively hard object is to be cut, the scissors in accordance with the present invention makes it possible to more smoothly cut the object than the conventional scissors having three pairs of blades.

### BEST EMBODIMENT FOR PUTTING THE INVENTION INTO PRACTICE

### First Embodiment

FIG. 1 is a plan view of scissors 100 in accordance with the first embodiment of the present invention, and FIG. 2 is a side view of the scissors 100.

The scissors 100 in accordance with the first embodiment is comprised of three pairs of blades 110, 120 and 130, a pair of handles 140, a rotation-center shaft 150, and two stopper shafts 160.

As illustrated in FIG. 2, the three pairs of blades 110, 120 and 130 are arranged in parallel with one another. The pair of blades 120 is disposed at the center among the three pair of blades, and the pairs of blades 110 and 130 are disposed at the opposite sides about the pair of blades 120.

Each of the pair of handles 140 is fixed to an end (a right end in FIG. 1) of each of the pair of blades 120 disposed at the center among the three pair of blades.

The pairs of blades 110 and 130 disposed at the opposite sides about the pair of blades 120 are fixed to the pair of blades 120 through the rotation-center shaft 150 at a rotation center of the three pairs of blades 110, 120 and 130.

The pairs of blades 110 and 130 disposed at the opposite sides about the pair of blades 120 are fixed at an end thereof to the pair of blades 120 through the two stopper shafts 160. Specifically, one of blades in each of the pairs of blades 110 and 130 is fixed to one of blades in the pair of blades 120 through one of the stopper shafts 160, and the other of blades in each of the pairs of blades 110 and 130 is fixed to the other of blades in the pair of blades 120 through the other of the stopper shafts 160

Accordingly, the three pairs of blades 110, 120 and 130 operate in synchronization with one another. Specifically, when a user of the scissors 100 rotates the handles 140 in such a direction as the handles 140 go away from each other, one of blades in each of the three pairs of blades 110, 120 and 130 rotate in a direction away from the other of blades, and when a user of the scissors 100 rotates the handles 140 in such a direction as the handles 140 approach each other, one of blades in each of the three pairs of blades 110, 120 and 130 rotate in a direction in which one of blades approaches the other of blades.

FIG. 3 is a plan view illustrating one of blades (a blade disposed lower in the scissors 100 illustrated in FIG. 1) in each of the three pairs of blades 110, 120 and 130.

As illustrated in FIG. 3, a blade in each of the three pairs of blades 110, 120 and 130 has a height different from others. Herein, the term “height” means a length of a blade at any location in a direction H (see FIG. 1) perpendicular to a center line of the scissors 100.

Specifically, as illustrated in FIG. 3, a blade in the pair of blades 110 disposed at a side of the pair of blades 120 disposed at the center among the three pairs of blades is designed to have a height A, a blade in the pair of blades 120 disposed at the center among the three pairs of blades is designed to have a height B, and a blade in the pair of blades 130 disposed at the other side of the pair of blades 120 is designed to have a height C. The height A is greatest, the height B is second greatest, and the height C is smallest among the heights A, B and C (A>B>C).

That is, a blade is higher in an order of the pair of blades 110, the pair of blades 120, and the pair of blades 130.

FIG. 4 illustrates a timing at which each of the three pairs of blades 110, 120 and 130 starts engaging with each other when a paper 170 as an object is to be cut by the scissors 100 in accordance with the first embodiment.

It is assumed that after the handles 140 are rotated in such a direction as the handles 140 go away from each other to thereby rotate the three pairs of blades 110, 120 and 130 in a direction as the blades in each of the pairs go away from each other, the paper 170 is put between the blades in the three pairs of blades 110, 120 and 130.

Intervals between the blades in the three pairs of blades 110, 120 and 130 at a moment when the handles 140 are rotated in a direction as the handles 140 are closed to thereby rotate the blades in the three pairs of blades 110, 120 and 130 in a direction as the blades are closed are designated as W1, W2 and W3. As illustrated in FIG. 4, W3 is greater than W2, and W2 is greater than W1 (W1<W2<W3).

Since the relation among the heights A, B and C among the blades in the three pairs of blades 110, 120 and 130 is defined as A>B>C as mentioned above, when the paper 170 is cut with the scissors 100 in accordance with the first embodiment, the pair of blades 110 disposed at a side about the pair of blades 120 disposed at the center among the three pairs of blades first starts engaging with each other to thereby start cutting the paper 170. Following the pair of blades 110, the pair of blades 120 disposed at the center among the three pairs of blades starts engaging with each other to thereby start cutting the paper 170. Then, the pair of blades 130 disposed at the other side about the pair of blades 120 starts engaging with each other to thereby start cutting the paper 170.

As mentioned above, in the scissors 100 in accordance with the first embodiment, each of the three pairs of blades 110, 120 and 130 starts engaging with each other at a timing different from one another, and accordingly, starts cutting the paper 170 at a timing different from one another.

The conventional scissors having three pairs of blades was accompanied with a problem that a big load exerted on a hand of a user, because the three pairs of blades simultaneously start engaging with each other. In contrast, since the three pairs of blades 110, 120 and 130 start cutting the paper 170 at a timing different from one another in the scissors 100 in accordance with the first embodiment, a load to be exerted on a hand of a user is divided, and hence, a big load does not exert at a time on a hand of a user. Thus, even if a relatively hard object is to be cut, the scissors 100 in accordance with the first embodiment makes it possible to more smoothly cut the object than the conventional scissors having three pairs of blades.

### Second Embodiment

FIG. 5 is a plan view of scissors 200 in accordance with a second embodiment of the present invention, and FIG. 6 is a side view of the scissors 200.

The scissors 200 in accordance with a second embodiment is designed to have five pairs of blades. The scissors 200 in accordance with the second embodiment is identical in structure with the scissors 100 in accordance with the first embodiment except having five pairs of blades.

Among the five pairs of blades in the scissors 200 in accordance with the second embodiment, a pair of blades 210 disposed at the center among the five pairs of blades is designed to have a height A similarly to the pair of blades 110 in the scissors 100 in accordance with the first embodiment, two pairs of blades 220 disposed at the opposite sides about the pair of blades 210 are designed to have a height B similarly to the pair of blades 120 in the scissors 100 in accordance with the first embodiment, and two pairs of blades 230 disposed outwardly adjacent to the pairs of blades 220 are designed to have a height C similarly to the pair of blades 130 in the scissors 100 in accordance with the first embodiment.

Thus, when a paper 170 (see FIG. 4) is to be cut with the scissors 200 in accordance with the second embodiment, the pair of blades 210 disposed at the center among the five pairs of blades first start engaging with each other to thereby start cutting the paper 170. Following the pair of blades 210, the pairs of blades 220 disposed at the opposite sides about the pair of blades 210 start engaging with each other to thereby start cutting the paper 170. Then, the pairs of blades 230 disposed outwardly adjacent to the pairs of blades 220 start engaging with each other to thereby start cutting the paper 170.

As mentioned above, in the scissors 200 in accordance with the second embodiment, similarly to the scissors 100 in accordance with the first embodiment, each of the five pairs of blades 210, 220 and 230 starts engaging with each other at a timing different from one another, and accordingly, starts cutting the paper 170 at a timing different from one another.

Accordingly, a load to be exerted on a hand of a user is divided, and hence, a big load does not exert at a time on a hand of a user. Thus, even if a relatively hard object is to be cut, the scissors 200 in accordance with the second embodiment makes it possible to more smoothly cut the object than the conventional scissors having three pairs of blades.

Though the scissors 100 in accordance with the first embodiment is designed to have three pairs of blades, and the scissors 200 in accordance with the second embodiment is designed to have five pairs of blades, a number of pairs of blades can be arbitrarily selected. A number of pairs of blades may be two or more.

In the scissors 100 in accordance with the first embodiment, a pair of blades disposed at an outermost first stars engaging with each other, and then, pairs of blades start engaging with each other in an order towards the other outermost pair of blades. In the scissors 200 in accordance with the second embodiment, a pair of blades disposed at the center among the five pairs of blades first start engaging with each other, and pairs of blades disposed adjacent thereto subsequently start engaging with each other. An order in which a plurality of pairs of blades starts engaging with each other is not to be limited to the order shown in the first and second embodiments. An order in which a plurality of pairs of blades starts engaging with each other may be arbitrarily selected, unless a location at which blades in a certain pair are engaged with each other is deviated from a location at which blades in a pair disposed adjacent to the certain pair are engaged with each other, and hence, a timing at which blades in the certain pair are engaged with each other is different from a timing at which blades in the pair disposed adjacent to the certain pair are engaged with each.

In the scissors 100 and 200 in accordance with the first and second embodiments, a timing at which blades in each of pairs start engaging with each other is set different from others by designing blades in each of pairs to have a height different from one another. It should be noted that a timing at which blades in each of pairs start engaging with each other may be set different from others in different manners.

For instance, when a plurality of pairs of blades is fixed to one another through a pair of the stopper shafts 160, it is possible to have the same advantage as the advantage provided by designing blades in each of pairs to have a height different from one another, by fixing each of pairs of blades at different angles from one another.

### BRIEF DESCRIPTION OF THE DRAWINGS

FIG. 1 is a plan view of scissors in accordance with the first embodiment of the present invention.

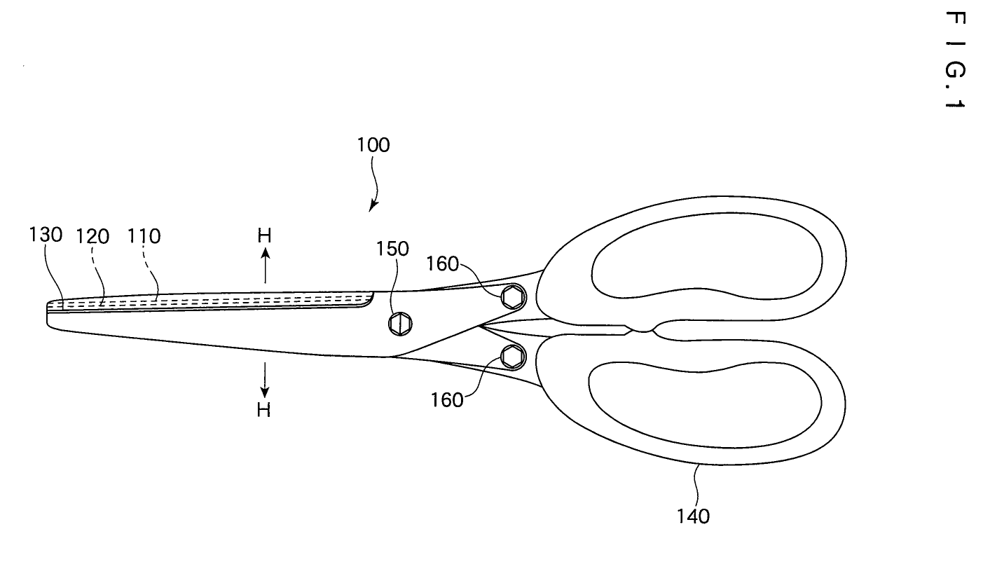

FIG. 2 is a side view of scissors in accordance with the first embodiment of the present invention.

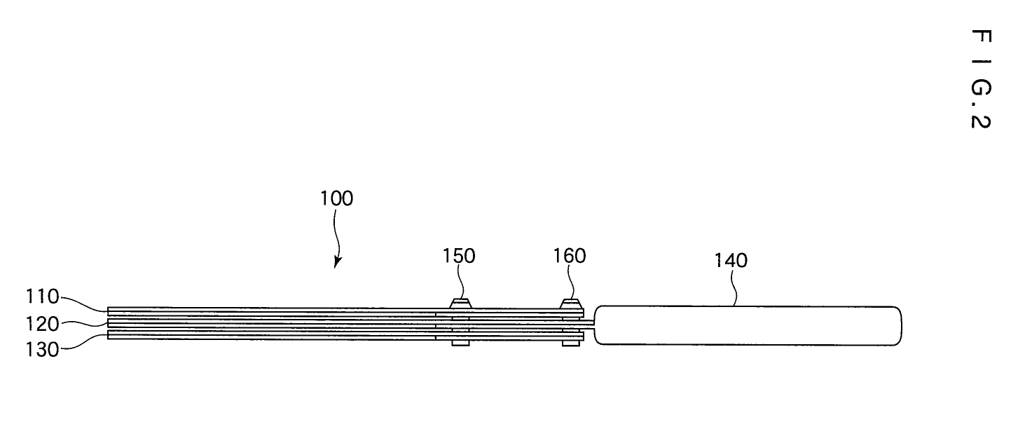

FIG. 3 is a plan view illustrating one of blades in each of the three pairs of blades in the scissors in accordance with the first embodiment of the present invention.

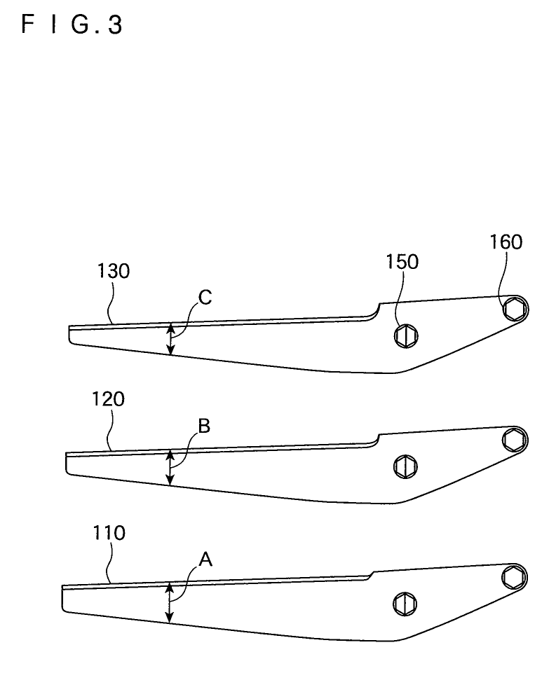

FIG. 4 illustrates a timing at which each of the three pairs of blades starts engaging with each other when a paper as an object is to be cut by the scissors in accordance with the first embodiment.

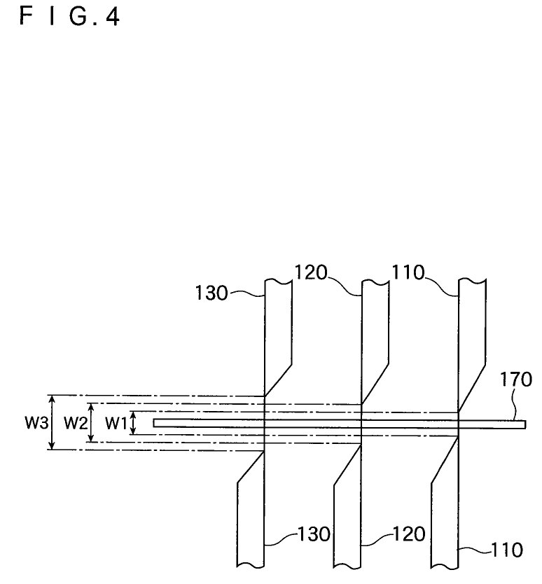

FIG. 5 is a plan view of scissors in accordance with the second embodiment of the present invention.

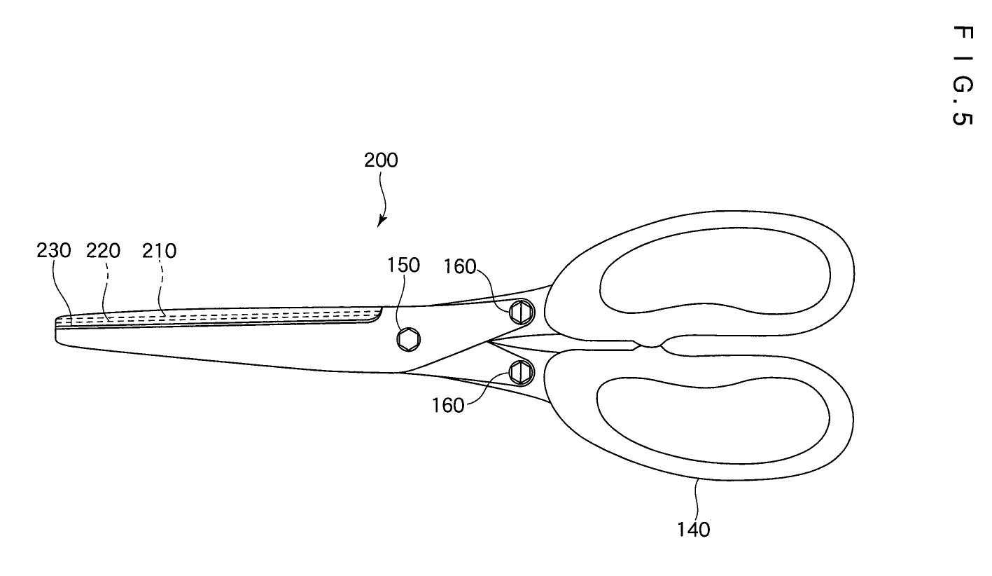

FIG. 6 is a side view of scissors in accordance with the second embodiment of the present invention.

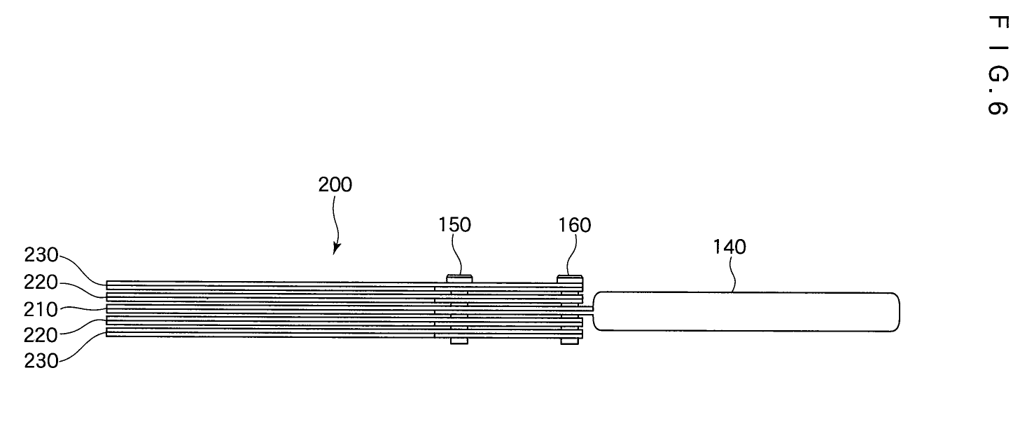

### INDICATION BY REFERENCE NUMERALS

100 Scissors in accordance with the first embodiment of the present invention
110, 120, 130 Pair of blades in the first embodiment
140 Handle
150 Rotary-center shaft
160 Stopper shaft
200 Scissors in accordance with the second embodiment of the present invention
210, 220, 230 Pair of blades in the second embodiment

1. Scissors including a plurality of pairs of blades arranged in parallel with one another,
wherein a first pair of blades among said plurality of pairs of blades deviates from a second pair of blades disposed adjacent to said first pair of blades with respect to a timing at which blades start engaging with each other.

2. The scissors as set forth in claim 1, wherein a pair of blades disposed at an outermost first starts engaging with each other, and, a pair of blades disposed adjacent thereto subsequently starts engaging with each other.

3. The scissors as set forth in claim 1, wherein a pair of blades disposed at a center among said plurality of pairs of blades first starts engaging with each other, and, a pair of blades disposed adjacent thereto subsequently starts engaging with each other.

4. Scissors including a plurality of pairs of blades arranged in parallel with one another,
wherein each pair of blades has a height different from one another among said plurality of pairs of blades.

5. The scissors as set forth in claim 4, wherein a pair of blades disposed at an outermost has a greatest height, and a pair of blades disposed remoter from said pair of blades disposed at an outermost has a smaller height.

6. The scissors as set forth in claim 4, wherein a pair of blades disposed at a center has a greatest height, and a pair of blades disposed remoter from said pair of blades disposed at a center has a smaller height.

7. The scissors as set forth in claim 4, wherein each pair of blades has a height different from one another among said plurality of pairs of blades by fixing each of pair of blades at different angles from one another.
